(19) United States
(12) Patent Application Publication
(10) Pub. No.: US 2006/0075623 A1
(43) Pub. Date: Apr. 13, 2006

(54) Method of manufacture of metal components

(76) Inventor: Dan Jones, Valley Mills, TX (US)

Correspondence Address: Robert L. Greeson;7th Floor, 900 Washington Avenue, P.O. Box 1470, Waco, TX, 77603-1470, US

(21) Appl. No.: 10/963,970

(22) Filed: Oct. 13, 2004

(51) Int. Cl. B23P 11/00; B23P 13/04

(52) U.S. Cl. 29/514; 29/505; 29/558

(57) ABSTRACT

An improved method of manufacture of metal components where a plurality of relatively thin, substantially planar sheets are selected and then cut using a laser cutter+or similar cutting means. The sheets are then layered upon one another and bonded or pressed together to form a final, laminated component.

### BACKGROUND OF THE INVENTION

1. Field of the Invention

The present invention generally relates to an improved method of manufacture of metal components. More specifically, the present invention relates to a method of manufacture where components are composed of or built in thin sheets or layers.

2. Background Information

In the manufacture of heavy machinery, component parts are usually forged from a single piece of stock metal. That is, a single stock block is usually machined to the desired dimensions of a particular component. This process requires a tremendous amount of time and energy. For example, to form a radial cylindrical member of approximately six inch depth and eighteen inch diameter, having several radially aligned apertures, would take heavy machinery and hours to produce. After all, the radial shell would have to be initially forged and then each aperture cut through the entire depth of the component. Such practice is unduly burdensome on anyone forging components in this manner.

Applicant's invention provides a straightforward, yet novel, solution to the problems mentioned above. By way of machining several relatively thin pieces of metal to achieve desired dimensions, and then layering those pieces upon one another to form the final three dimensional component, a tremendous amount of time and energy is saved. Primarily, time and energy is saved as each thin piece may be “laser cut” and then layered upon each other. Although the end result may be the same, the energy required to achieve that result is dramatically reduced. By way of practical example, if the radial member referenced above were to be forged from a single piece—only a relatively small percentage of machinist (those having the largest, most expensive tools) would be able to accomplish the task. Such is the result as a tremendous amount of power is required to cut through the entire depth of the components. However, if the same radial member were made by cutting each relatively thin (i.e., one quarter inch) piece to have the appropriate diameter and radially aligned apertures and layering each piece upon the other, much cheaper equipment may be used. As such, the lamination process of the present invention can be accomplished by most machinists, equipped with a relatively inexpensive laser cutter or some equivalent thereof. Perhaps the novelty of the present invention lies in the fact that the sum of the energy required to cut each layered piece is much less than the energy required to cut the single, thick piece.

The method of the present invention may be performed by relatively small, inexpensive tools. As such, machine shops of even modest capability will be able to produce components they couldn't produce before. Components that were once expensive to produce will be now be made in a much cheaper fashion. The cost saving associated with the present method strongly speaks to the novelty of the method.

In view of the above, a great need exists for a process by which relatively large, complex metal components can be formed with inexpensive tools in a remarkably small period of time. Applicant's invention provides such a process. By way of lamination, thin pieces may be cut to appropriate dimension and then layered upon one another to form a single component. The time and energy saved in cutting several thin such pieces rather than a single, thick piece is tremendous.

### SUMMARY OF THE INVENTION

The general purpose of the present invention, which will be described subsequently in greater detail, is to provide a method of manufacturing metal components that provides an improvement both with respect to the time and energy typically required to produce such components.

In further view of such, it is an object of the present invention to provide an improved method of manufacture of metal components whereby simple and inexpensive tools can be used.

It is another object of the present invention to provide an improved method of manufacture of metal components whereby a laser cutter can be used.

It is another object of the present invention to provide an improved method of manufacture of metal components whereby relatively thin pieces of component material are used in place of a single piece.

It is another object of the present invention to provide an improved method of manufacture of metal components whereby relatively thin pieces of component material are layered upon one another to form a final component.

It is another object of the present invention to provide an improved method of manufacture of metal components that establishes a tremendous improvement in the time required to compete such.

It is another object of the present invention to provide an improved method of manufacture of metal components that establishes a tremendous improvement in the power required to compete such.

It is another object of the present invention to provide an improved method of manufacture of metal components where relatively thin pieces of component material are affixed to one another through some affixing process.

In view of the foregoing and other related objectives, Applicant's invention provides a method in which relatively thin pieces of component material are layered upon one another to form a single, laminated component. Using this method, individual pieces may be cut in any number of ways and placed in combination with other pieces to provide a single component. Combining relatively thin pieces, all of which may be configured in any number of ways, allows extremely complex component pieces to be formed. For many purposes laminated components perform as well as pieces forged from a single piece of stock metal.

The first step of the present method involves selecting a plurality of relatively thin, substantially planar, sheets of metallic material. This material may be comprised of a single metal, or some alloy thereof, depending on the desired properties of the final component pieces. In its most preferred form, these relatively thin, substantially planar, pieces are between one eighth of an inch and one inch in thickness.

Next, each planar sheet is cut according to some two dimensional reference, such as a flat template or equivalent thereof. As mentioned, these planar sheets are typically between one eighth of an inch to one inch in thickness. Accordingly, these sheets may be cut with smaller, less expensive tools. In its most preferred form, the present invention employs use of a laser cutter as known in the art. Use of a laser cutter is extremely fast and relatively accurate in the production of specifically cut pieces. Importantly, the layered pieces may be of varying widths—this allows a greater degree of precision in forming the final components.

After the sheets have been cut according to the desired dimensions, they are layered upon one another to form the final three dimensional component. Each layer may then be bonded or pressed together, sometimes under heat, to form a final laminated component. This lamination process, as described, provides a significant reduction in both production time and the energy required to make the final component.

### BRIEF DESCRIPTION OF THE DRAWINGS

FIG. 1 is a perspective view of a product of the method of the present invention.

FIG. 2 is a flow chart diagram of the preferred embodiment of the method of the present invention.

### DETAILED DESCRIPTION OF THE PREFERRED EMBODIMENT

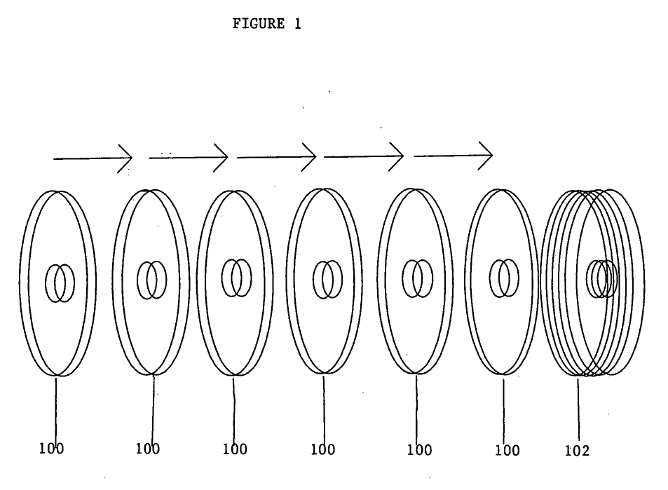

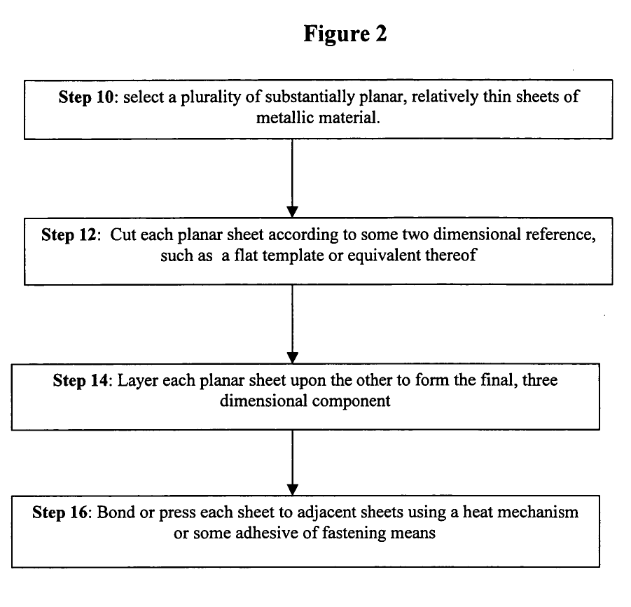

A description of the general method of the preferred embodiment of the present invention is given as follows. Referring to FIG. 1 and FIG. 2, the method of the present invention commences at step 10, where a plurality of substantially planar, relatively thin sheets of metallic material 100 are selected. Metallic Sheets 100, in the preferred embodiment, may be comprised of single metal or some alloy thereof, depending on the desired characteristic of the final component piece. Further, in the preferred embodiment, sheets 100 are of thickness between one eight of and inch to one inch in thickness. Such a thickness is preferred as this allows each sheet 100 to be cut with relatively small, non expensive tools such as a laser cutter, and allows each sheet 100 to be thick enough to actually be useful. However, as will be apparent to those skilled in the art, narrower pieces may be preferred for particularly small or particularly detailed components; while thicker pieces may be preferred for particularly large or simple pieces. Summarily, each sheet 100 may be of varying widths—this allows a greater degree of precision in forming the final components.

At step 12, each planar sheet 100 is cut according to some two dimensional reference, such as a flat template or equivalent thereof. As mentioned, each sheet 100 is cut using a tool such as a laser cutter. Laser cutters are preferred as they are relatively accurate, perform in a fast manner, are easy to operate, and are relatively energy efficient.

At step 14, each planar sheet is layered upon the other to form the final, three dimensional component 102. At step 14, a significant advantage of the present method is realized. That is, the time and energy spent cutting and assembling each sheet 100 to form component 102 is significantly less than that spent to forge a single component piece of the exact dimension of assembled component 102. This saving in respect to time and energy increases super-linearly as the thickness and complexity of assembled component 102 increases. As such, the present method is particularly more useful for relatively thick components.

At step 16, each sheet 100 is pressed or bonded to adjacent sheets 100. Step 16 may be performed using a heat mechanism or some adhesive. According to the desired operation of function of assembled component 102, step 16 may be performed by inserting some fastening means through each sheet 100. Such a fastening means may a combination of screws or pins as known in the art.

In the detailed description to follow a product of the method of the present invention is described. However, the product is not offered in a limiting sense, but rather is offered as one of several example products that may result from the method of the present invention. Other such products will certainly be apparent to those skilled in the art upon reference to this disclosure. For example, the method of the present invention is thought to be particularly useful in production of “A Device for Actuating a Reciprocating Recovery Means for Underground Fluid,” best described in a patent application filed on Oct. 12, 2004, having U.S. Express Mail # EV 298572059 US, a copy of which accompanies this application as appendix A.

Referring again to FIG. 1 and FIG. 2, a radial component having a diameter of eighteen inches, a thickness of six inches, a central aperture having a six inch diameter, and a series of radially aligned apertures each having a diameter of one inch is shown. At step 10, six, one inch, sheets 100 are selected. In this example each sheet is of a rectilinear dimension. At step 12, each sheet 100 is cut, with a laser cutter, to have an eighteen inch diameter, a central aperture having a six diameter, and a series of radially aligned apertures having a diameter of one inch. At step 14, all six sheets 100 are layered upon each other to so that the commination of the sheets forms an eighteen inch by six inch member, having the apertures as described above. Finally, at step 16, sheets 100 are pressed on bonded togther using some heating means, adhesive means, or fastening means as known in the art.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A method of manufacturing three dimensional metallic components, comprising the steps of:
selecting a plurality of relatively thin, substantially planar metallic sheets;
cutting said metallic sheets according to some two dimensional reference;
assembling said cut metallic sheets so that the assemblage of said sheets forms a three dimensional component piece according to desired dimensions;
bonding or pressing said cut, assembled sheets to one another by some bonding or pressing means.

2. The method of claim 1 wherein said metallic sheets are cut and assembled to form an input component of a reducer type torque variation device.

3. The method of claim 1 wherein said metallic sheets are cut and assembled to form an output component of a reducer type torque variation device.

4. The method of claim 1 wherein said metallic sheets are cut and assembled to form an input component of a device for actuating a reciprocating recovery device of underground fluid.

5. The method of claim 1 wherein said metallic sheets are cut and assembled to form an output component of a device for actuating a reciprocating recovery device of underground fluid.
